(19) United States
(12) Patent Application Publication
(10) Pub. No.: US 2014/0237899 A1
(43) Pub. Date: Aug. 28, 2014

(54) SPLIT-DOOR HANDLE

(71) Applicant: DLP LIMITED, Douglas (GB)

(72) Inventors: Ian Felmeri, Castletown (GB); Thomas Doyle, Braddan (GB)

(21) Appl. No.: 14/350,099

(22) PCT Filed: Oct. 7, 2011
(86) PCT No.: PCT/GB2011/051935

§ 371 Date: Apr. 7, 2014

(51) Int. Cl. A47K 3/36; E05D 15/48; E06B 3/36; B25G 3/38

(52) U.S. Cl. CPC A47K 3/36; B25G 3/38; E05D 15/48; E06B 3/362; E05D 2015/485
USPC 49/168; 16/430

(57) ABSTRACT

A split-door handle for releasably interengaging upper and lower door-leaves of a split-door is provided and comprises a pivotable hand-grip element, a first door-engagable support which supports the hand-grip element to pivotably move between an upper and lower door-leaf engagement condition whereby upper and lower door-leaves of a split-door are interengaged for simultaneous movement and a upper and lower door-leaf release condition whereby the upper and lower door-leaves of the split-door are movable independently, a second door-engagable support which is spaced from the first door-engagable support and by which the hand-grip element is positively retained in the said engagement condition, and a detent at the first door-engagable support to positively hold the hand-grip element in the said second condition.

The present invention relates to a split-door handle and more particularly, but not necessarily exclusively, to a split-door for a shower installation having such a handle.

Split-door shower screens are not particularly common, but can be useful for a seated individual requiring assistance during showering. Such occasions arise when there is a wheelchair-bound user or an invalid or infirm user. By having an upper door-leaf which is closeable, an able-bodied user can then shower normally.

However, a problem with split screen doors is that a separate handle is required for each door-leaf, and this increases manufacturing, packaging, transportation and installation costs.

It is therefore an objective of the present invention to provide a split-door handle that can conveniently operate upper and lower door-leaves simultaneously or independently.

According to a first aspect of the present invention, there is provided a split-door handle for releasably interengaging upper and lower door-leaves of a split-door, the split-door handle comprising a pivotable hand-grip element, a first door-engagable support which supports the hand-grip element for pivotable movement between an upper and lower door-leaf engagement condition whereby upper and lower door-leaves of a split-door are interengaged for simultaneous movement and a upper and lower door-leaf release condition whereby the upper and lower door-leaves of the split-door are movable independently, a second door-engagable support which is spaced from the first door-engagable support and by which the hand-grip element is positively retained in the said engagement condition, and a detent at the first door-engagable support for positively holding the hand-grip element in the said second condition.

Preferable and/or optional features of the first aspect of the invention are set forth in claims 2 to 11, inclusive.

According to a second aspect of the invention, there is provided a split-shower door for a shower installation, the split-shower door comprising upper and lower independently movable door-leaves and a split-door handle in accordance with the first aspect of the invention which in the upper and lower door-leaf engagement condition interengages the upper and lower door-leaves for simultaneous movement via the split-door handle and which in the upper and lower door-leaf release condition enables independent movement of the upper and lower door-leaves via the split-door handle.

The present invention will now be more particularly described, by way of example only, with reference to the accompanying drawings, in which:

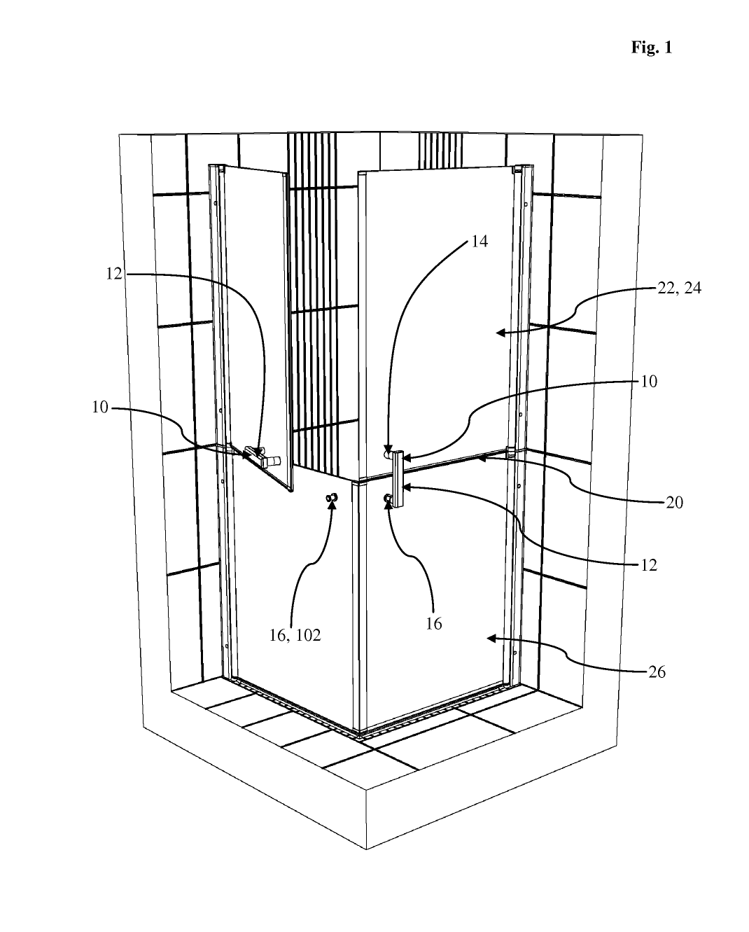

FIG. 1 is a perspective view of a shower installation having two split-shower doors, each split-shower door is operable by a split-door handle according to the first aspect of the invention;

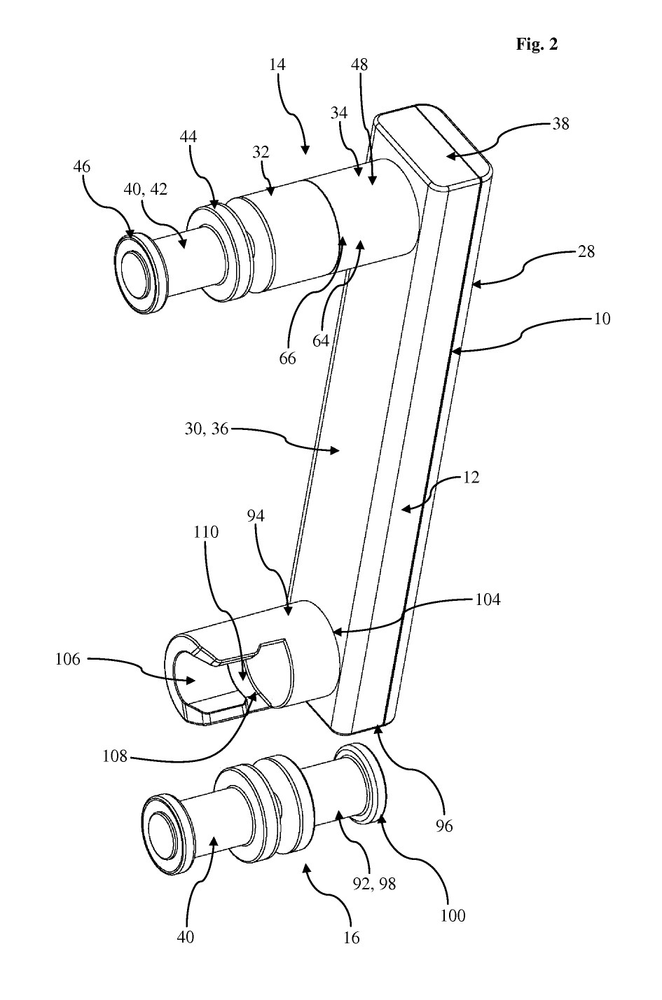

FIG. 2 is an enlarged perspective view of the split-door handle, shown in isolation and from a reverse side;

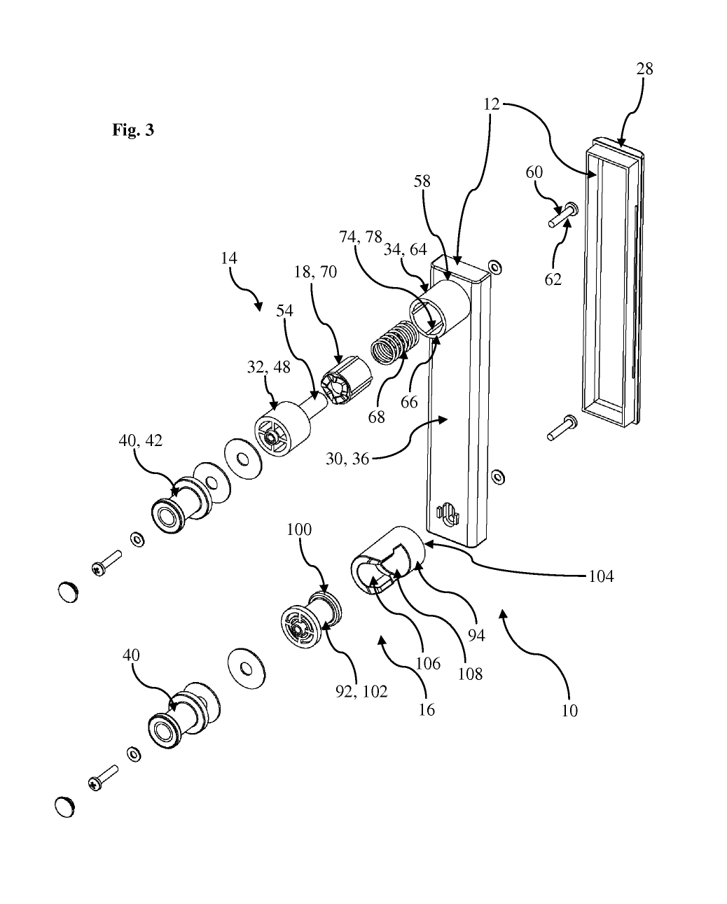

FIG. 3 is an exploded view of the split-door handle;

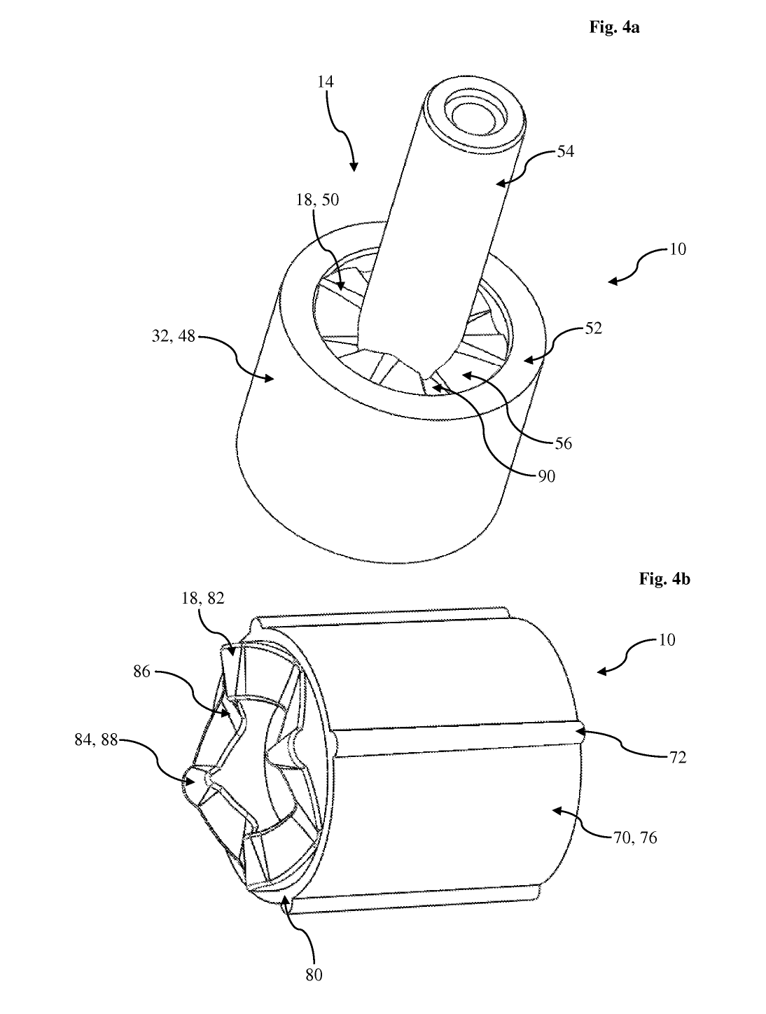

FIG. 4a is an enlarged perspective view of a first interengagable boss of the split-door handle and showing part of a detent; and

FIG. 4b is an enlarged perspective view of another part of the detent.

Referring to the drawings, there is shown one embodiment of a split-door handle 10 which comprises a pivotable hand-grip element 12, a first door-engagable support 14, a second door-engagable support 16, and a detent 18 for positively holding the hand-grip element 12 in at least one pivoted condition, in this case being at least a horizontal position.

The hand-grip element 12 is, in this embodiment, rigid, elongate and straight having bevelled edges and corners. However, many other shapes and design of grip are possible, such as curved, sinusoidal or wavy, and ergonomically profiled. The hand-grip element 12 has a longitudinal extent which is sufficient to allow it to span a split 20 between an upper door-leaf 22 of a split-door 24 and a lower door-leaf 26. However, it has a lateral extent which, when pivoted, does not overlap the split 20 thereby causing an obstruction. Preferably, the hand-grip element 12 is formed in two longitudinal parts, being front and back members 28, 30, and these can be conveniently snap-fit interengaged together.

The first door-engagable support 14 comprises first and second axially interengagable spools or bosses 32, 34, the first boss 32 being fastened to the upper door-leaf 22 via a connector 40 which typically extends through a thickness of the door-leaf, and the second boss 34 being provided on a rear side 36 of the hand-grip element 12 at or adjacent to a first end 38. The connector 40 may be plastics or metal and preferably includes a body 42, an enlarged head 44 and an enlarged tail 46. The enlarged head 44 and/or the enlarged tail 46 may be releasable from the body 42 so that the door-leaf can be effectively clamped therebetween. Preferably, a waterproof or water-resistant grommet is supplied for insertion through an aperture in the door-leaf and which is adapted to receive the body 42.

The first boss 32, as best seen in FIG. 4a, comprises a generally cylindrical support body 48, a first part 50 of the detent 18 at least in part recessed relative to an outer wall 52 of the support body 48, and an axially projecting spigot 54 which extends from a centre of the first part 50 of the detent 18. Preferably, the first boss 32 is an integrally formed one-piece element, typically being formed from plastics or metal. The first part 50 of the detent 18 preferably presents an endless undulatory, cam or stepped surface 56 extending around the rotational axis of the first door-engagable support 14.

The second boss 34 as seen in FIG. 3 is, in this case, integrally formed as one-piece with the back member 30 of the hand-grip element 12. A first end 58 of the second boss 34 which is proximal to the back member 30 is accessible from within the hand-grip element 12 to enable the passage of a shaft 60 of a fastening device 62, such as a screw or bolt. The fastening device 62 engages the spigot 54 when received in the second boss 34.

A body 64 of the second boss 34 is at least in part hollow, and a second end 66 which is distal of the back member 30 is open to receive a biasing device 68, in this case being a coil spring, and a slidable second part 70 of the detent 18 as best seen in FIG. 4b. At least one key 72 and complimentary keyway 74 are formed on a detent body 76 of the second part 70 of the detent 18 and an interior surface 78 of the second boss 34. The key 72 and keyway 74 extend in parallel or substantially parallel with a rotational axis of the first door-engagable support 14. In this case, the key 72 is a straight elongate ridge which extends from one end of the detent body 76 to the other along an outer surface, and the keyway 74 is a runner channel which slidably receives the key 72 and which extends from the distal second end 66 of the second boss 34 to or substantially to the proximal first end 58.

A distal end 80 of the detent body 76 includes an endless undulatory or cam surface 82 having a generally continuous sinusoidal profile around the rotational axis of the first door-engagable support 14. The cam surface 82 includes alternating crests 84 and troughs 86. Each crest 84 preferably includes a pronounced apex 88 which is receivable in a substantially complimentarily shaped secondary recess 90 of the stepped surface 56 of the first part 50 of the detent 18.

With the first and second bosses 32, 34 assembled to include the detent 18 therebetween, as the hand-grip element 12 is rotated, the cam surface 82 of the detent body 76 rides on the stepped surface 56 of the first part 50 of the detent 18. The respective undulations are accommodated by the spring-biasing of the detent body 76. As each pronounced apex 88 is received in its respective secondary recess 90, the hand-grip element 12 is positively held in that selected angular position until a user reasserts a turning force.

The second door-engagable support 16 is spaced from the first door-engagable support 14 and comprises first and second laterally engagable spools or bosses 92, 94. Preferably, the first and second laterally engagable bosses 92, 94 are formed of plastics or metal. The first laterally engagable boss 92 is fastened to the lower door-leaf 26 via another said connector 40 which again beneficially extends through the thickness of the door-leaf. The second laterally engagable boss 94 is fastened to the rear side 36 of the hand-grip element 12 at or adjacent to a second end 96 which is opposite the first end 38.

The first laterally engagable boss 92 includes a, preferably generally cylindrical, body 98 and an enlarged head 100 which extends radially beyond the body 98. The enlarged head 100 of the first laterally engagable boss 92 in this case conveniently forms a knob-like secondary hand-grip element 102 for a user to grip and move the lower door-leaf 26, when the first said hand-grip element 12 is angularly displaced therefrom.

A first end 104 of the second laterally engagable boss 94 is proximal to the back member 30 and is accessible from within the hand-grip element 12 to enable the passage of a shaft 60 of a further said fastening device 62.

The second laterally engagable boss 94 is at least in part hollow, and as such has an open distal second end 106 and a side opening 108 which extends from the open distal second end 106. The side opening 108 is adapted to receive the body 98 and enlarged head 100 of the first laterally engagable boss 92 as a releasable snap-fit. A bore 110 of the hollow interior of the second laterally engagable boss 94 is complimentarily stepped to match or substantially match the body 98 and enlarged head 100 of the first laterally engagable boss 92. To bias the enlarged head 100 of the first laterally engagable boss 92 against a shoulder of the stepped bore 110 of the second laterally engagable boss 94, to take up any play, a part-spherical protuberance is positioned axially on the free major surface of the enlarged head 100.

In the present embodiment, the first door-engagable support 14 is mounted to the upper door-leaf 22 of a horizontally split-door 24, in this case being a shower door of a shower installation. The split-door 24 is thus preferably formed of water-resistant materials, and may include one or more translucent panes of glass or plastics. The second door-engagable support 16 is mounted to a lower door-leaf 26 of a horizontally split-door 24. Typically, the first and second door-engagable supports 14, 16 are vertically or substantially vertically aligned. The hand-grip element 12 is supported by the first door-engagable support 14 for pivotable movement therearound. As mentioned above, the detent 18 positively holds the hand-grip element 12 in one or more angular positions about a rotational axis of the first door-engagable support 14. Typically, the angular positions will be at least horizontal, and preferably also vertical. Consequently, in the horizontal position, the hand-grip element 12 can be used to move the upper door-leaf 22 independently of the lower door-leaf 26 as will be appreciated in FIG. 1.

With the hand-grip element 12 held by the detent 18 in the horizontal position, the first laterally engagable boss 92 of the second door-engagable support 16 is separated from the second laterally engagable boss 94 and thus presents itself as the knob-like secondary hand-grip element 102, thereby allowing independent movement of the lower door-leaf 26.

The hand-grip element 12 can then be rotated from the above described upper and lower door-leaf release condition to an upper and lower door-leaf engagement condition, whereby the upper and lower door-leaves 22, 26 of the split-door 24 are interengaged for simultaneous movement via the hand-grip element 12. In this case, the hand-grip element 12 is swung against the positive engagement of the detent 18 to assume a vertical position. This thus results in the first and second laterally engagable bosses 92, 94 being releasably engaged with each other, thereby interlocking the upper and lower door-leaves 22, 26, as shown again in FIG. 1. The upper and lower leaves 24, 26 can be released by pivoting the hand-grip element 12 back to the horizontal.

Although the hand-grip element 12 is rotatably mounted to the upper door-leaf 22, it can be mounted to the lower door-leaf 26 with the second door-engagable support 16 being on the upper door-leaf 22.

It is thus possible to provide a split-door handle which is particularly suitable for a split-shower door of a shower installation. The split-door handle locks and unlocks the upper and lower leaves relative to each other, dependent on the angular position of the hand-grip element. With the hand-grip element in a release condition, affirm and positive separation is realised between the two leaves along with providing a secondary knob-like handle for operating the door leaf to which the hand-grip element is not mounted. With the hand-grip element in an engagement condition, a very positive latch is provided forming a firm and stable link between the two door sections or leaves.

The embodiments described above are provided by way of examples only, and various other modifications will be apparent to persons skilled in the art without departing from the scope of the invention as defined by the appended claims.

1. A split-door handle for releasably interengaging upper and lower door-leaves of a split-door, the split-door handle comprising a pivotable hand-grip element,
a first door-engagable support which supports the hand-grip element to pivotably move between an upper and lower door-leaf engagement condition whereby upper and lower door-leaves of a split-door are interengaged for simultaneous movement and a upper and lower door-leaf release condition whereby the upper and lower door-leaves of the split-door are movable independently, a second door-engagable support which is spaced from the first door-engagable support and by which the hand-grip element is positively retained in the said engagement condition, and a detent at the first door-engagable support to positively holding the hand-grip element in the said second condition.

2. The split-door handle as claimed in claim 1, wherein the first door-engagable support includes first and second axially interengagable bosses, the detent being provided at an interface of the bosses.

3. The split-door handle as claimed in claim 1, wherein the detent includes an endless spring-biased undulatory element and a complimentary receiver.

4. The split-door handle as claimed in claim 1, wherein the second door-engagable support includes first and second laterally engagable bosses.

5. The split-door handle as claimed in claim 4, wherein the first laterally engagable boss includes a body and an enlarged head, and the second laterally engagable boss is at least in part hollow having an open distal end and a side opening to receive the body and the enlarged head.

6. The split-door handle as claimed in claim 5, wherein the side opening is adapted to receive the body and enlarged head as a releasable snap-fit.

7. The split-door handle as claimed in claim 6, wherein a bore of the hollow interior of the second laterally engagable boss is complimentarily stepped to match or substantially match the body and enlarged head of the first laterally engagable boss.

8. The split-door handle as claimed in Claim 5, wherein the first laterally engagable boss includes an axially positioned part-spherical protuberance to axially bias the enlarged head within the second laterally engagable boss.

9. The split-door handle as claimed in claim 5, wherein the enlarged head is adapted to be gripped by a user, so that the first laterally engagable boss can be utilized as a supplementary handle to independently move one of the upper and lower door-leaves.

10. The split-door handle as claimed in claim 1, wherein the pivotable hand-grip element is rigid and elongate.

11. The split-door handle as claimed in claim 1, wherein the first and second door-engagable supports include connectors to connect the respective supports to the upper and lower door-leaves of the split-door.

12. A split-shower door for a shower installation, the split-shower door comprising upper and lower independently movable door-leaves and a split-door handle as claimed in claim 1 which in the upper and lower door-leaf engagement condition interengages the upper and lower door-leaves for simultaneous movement via the split-door handle and which in the upper and lower door-leaf release condition enables independent movement of the upper and lower door-leaves via the split-door handle.
